(19) United States
(12) Patent Application Publication
(10) Pub. No.: US 2011/0295422 A1
(43) Pub. Date: Dec. 1, 2011

(54) METHOD AND DEVICE FOR CONTROLLING A MANIPULATOR SYSTEM

(76) Inventor: Torsten Hasenzahl, Dillingen (DE)

(21) Appl. No.: 13/133,726

(22) PCT Filed: Nov. 2, 2009
(86) PCT No.: PCT/EP2009/007837

§ 371 Date: Aug. 8, 2011

(30) Foreign Application Priority Data
Dec. 9, 2008 (DE) 10 2008 061 172.7

(51) Int. Cl. B25J 13/00

(52) U.S. Cl. 700/245; 901/2

(57) ABSTRACT

A method for controlling a manipulator system, such as a robot system, having at least two driven axes connected to a power supply, includes selecting an axis of the manipulator system, monitoring the selected axis for a standstill state, and disconnected the selected axis from the power supply if it is detected that the selected axis is not in the standstill state, while maintaining the other non-selected axis connected to the power supply.

### BACKGROUND OF THE INVENTION

1. Field of the Invention

The present invention concerns a method and a device to control a manipulator system, in particular of a robot system, which has at least two drivable axes, a manipulator system with such a device and a computer-readable storage medium encoded with program instructions to implement such a method.

2. Description of the Prior Art

A manipulator system generally includes one or more manipulators, in particular robots (such as industrial or service robots), and can additionally have additional axes external to the manipulator(s) or, respectively, auxiliary axes. For example, a welding station can have a six-axis industrial robot that drives an electrode holder as well as a rotating table on which can be mounted two workpieces that can be rotated around a drivable seventh or eighth axis, such that a workpiece can always be processed by a robot and for this purpose can be rotated round the seventh or eighth axis while an operator removes or newly mounts a different workpiece. After the processing and the mounting of the new workpiece, the rotating table rotates around a ninth axis so that the robot processes the newly mounted workpiece and the operator can remove the processed workpiece.

In particular, if people interact with a manipulator system it must be ensured that they are not injured given a malfunction of the controller of the system. In general a regulator that emits control commands to actuators of the manipulator system (in particular to drive its axes) on the basis of fed back real values and their comparison with predetermined desired values is presently also designated as a controller. For example, it can be a programmable robot controller or superordinate process controller (SPC).

In order to ensure safety given an unscheduled movement of the manipulator system independent of the controller (that, for example, emits incorrect control commands due to calculation, measurement or model errors), from the standard EN 60204-1 it is known to disconnect the drives from the power supply immediately upon detection of the error (known as “STOP 0”), wherein if necessary the residual energy present in the manipulator can be used to brake or shut down the axes in order to assist engaged mechanical brakes via motors, or to additionally supply the drives with power to apply braking forces and only to disconnect from the power supply after the shutdown (what is known as “STOP 1”). Opposite parallel forces (i.e. torques) are also generally designated as forces, such that what is understood by a force sensor is also a torque sensor, for example.

In this regard EP 1 935953 B1 also proposes to drive a robot into a safety position and in this safety position to monitor all axes of the robot for shutdown if an operator enters a safety space, and to interrupt the power supply to all drives in order to execute a STOP 1 when at least one axis moves unscheduled into the safety position.

Here the violation of a shutdown monitoring by an axis of the robot disadvantageously already requires a complicated resumption of the operation after the complete STOP 1 of all axes. Additional axes of a manipulator system—in particular axes external to the manipulator—are not taken into account at all.

### SUMMARY OF THE INVENTION

An object of the present invention to improve the operation of a manipulator system, in particular a robot system.

A manipulator system according to the invention has one or more manipulators (in particular robots) and has at least two drivable axes that for this purpose are connected with a power supply.

The axes can be axes of the manipulator or manipulators that serve for the movement of a work point of the manipulator, in particular its tool reference coordinate system (known as the tool center point). For example, a welding robot can have six rotation axes that can be individually driven by electromotors connected with the power supply; a palletizing robot has four rotation axes, of which the first and fourth are aligned parallel to one another; the second and third are aligned parallel to one another and perpendicular to the first axis.

The manipulator system can additionally have one or more axes external to the manipulator, which in particular can be provided to move a workpiece. For example, the turning positioner described in the preceding can have a rotating table axis as well as additional rotation axes for positioning of workpieces on the rotating table.

An axis thereby represents in general a movement possibility or an actuatable degree of freedom of the manipulator system. A rotation axis (which for example can be driven by an electromotor) thus describes a degree of rotation freedom; a linear axis (that, for example, can be driven by a linear motor or by an electromotor via a gearing) describes a degree of translation freedom.

According to the invention one or more axes of the manipulator system is/are selected and monitored for shutdown. In the event that it is detected that one of these selected axes is not stopped, this axis is specifically disconnected from its power supply while—according to the innovation—the unselected axes continue to remain connected with the power supply. In this way the unnecessary STOP 1 of all axes—thus also those that were not selected for shutdown monitoring since they are not relevant to safety, for example—and the cost connected with this are avoided given a resumption of the operation. The unselected axes can advantageously continue to be activated in the predetermined manner and, for example, bring a planned movement to its end.

In the example of a welding cell explained in the preamble, the welding robot and the workpiece that is to be directly processed by it are, for example, located in a work space that is secured against admission while the operator removes or newly mounts the other workpiece in a manual loading station. The operator can thus be injured only by an unscheduled movement of the axis for rotation of the workpiece that is currently to be removed or mounted, possibly due to an unscheduled movement of the rotating table. In this example, these axes can therefore advantageously be selected and monitored for stopping. If an unscheduled movement of one of these selected axes occurs, the corresponding axis is disconnected from the power supply in order to ensure that the operator is not injured, independent of the control of the manipulator system. By contrast, the unselected axes of the welding robot and of the workpiece to be processed by it in work space remain in the predetermined controller and for this continue to be supplied with power. In contrast to a disconnection of all drives from the power supply, a burning of welding wire to ash can be prevented.

In a preferred embodiment of the present invention, the selected axis is immediately disconnected from the power supply as soon as it is detected that this axis is not at a standstill, meaning that a STOP 0 has been implemented for this axis. A high degree of safety can thereby be ensured, independently of errors of the controller.

Alternatively, the selected axis can be disconnected from the power supply only after this axis has been brought to a standstill while being supplied with power, meaning that a STOP 1 has been implemented for this axis. The braking time to stop the axis that is moving in an unscheduled manner can thereby be reduced. In both cases a mechanical braking occurs as soon as it is detected that this axis has not stopped, or as soon as the axis moving in an unscheduled manner has been re-stopped while being supplied with power in order to additionally reduce the braking time, or to safely bring the axis to a halt and protect it against an unexpected startup.

Both alternatives can be combined with one another by the selected axis being stopped while supplied with power, meaning that a STOP 1 is executed in the event that it is detected that this axis is not stopped due to an external interference (for example a contact by an operator or a collision with a moving obstacle) while otherwise the selected axis is disconnected from the power supply, meaning that a STOP 0 is executed as soon as it is detected that this axis has not been brought to a stop. The braking time can thus be reduced utilizing the drive of the axis that is correspondingly activated for this purpose when the controller and the drive function correctly, and the movement of the axis results from an external interference (for example the operator forcibly rotates the workpiece to be extracted around its workpiece axis in the manual loading station). In contrast to this, if it cannot be determined that an external interference is responsible for the unscheduled movement, the danger exists that the controller cannot function correctly and therefore also cannot be reliably used for braking, such that in this case a STOP 0 is implemented with immediate disconnection of the power supply and the occurrence of mechanical braking.

The decision can thereby similarly be made on the basis of a signal that indicates whether the controller and drive function correctly, or on the basis of a signal that indicates an external interference and, for example, can be generated by a force sensor to detect additional external forces or the like.

The activation of the standstill monitoring and/or the monitored standstill position of the selected axis is preferably variably predeterminable depending on a state of the manipulator system, a position of a manipulator, the time and/or a user input.

For example, a state of the manipulator system used in this context can be the opening or closing state of safety gates to work spaces or the like. For instance, as long as both safety gates (to the work space behind a four-axis palletizing robot and to a region in front of the robot) are closed, no axis is monitored for a standstill. If the gate to the region in front of the robot is opened, its first vertical rotation axis is monitored for a standstill in order to prevent the palletizing robot from breaching this region with its gripper by rotation around this axis. In contrast, if the gate to the work space is opened, its second and third horizontal rotation axes are monitored in a standstill position that corresponds to a maximum vertical extension of the robot in order to secure the work space under the extended robot in any case.

For example, a position of the manipulator used in this context can be described by the attitude and/or orientation of a coordinate system fixed to the manipulator, in particular its tool center point (TCP) by the positions of its drives or elements or the like, which can be transformed into one another corresponding to the translation relationships of gears between drive and driven manipulator element or by solving the forward or backward kinematics. Depending on such a position, the axes that are monitored for a standstill, and/or the standstill positions in which these are monitored for a standstill, can also be variably predetermined.

For example, a path or trajectory of the manipulator can provide one or more operating halts in which one or more of the selected axes should be safety stopped and secured against unexpected startup. If the manipulator reaches such an operating halt, the corresponding axes are monitored for a standstill until the manipulator leaves this operating halt again according to plan.

For example, a sixth tool axis of an industrial robot should not move during a tool exchange while the remaining axes move to occupy the tool placement position or tool take-up position. Therefore, for each operating halt for tool exchange an individual standstill position of the tool axis (which standstill position is dependent on the position of the manipulator) is predetermined and monitored in that the manipulator can deposit the old tool or can take up the new tool. These standstill positions depend on the respective tool, and therefore on the position of the robot relative to a tool exchange cabinet or the like.

Manipulators frequently travel predetermined trajectories in a chronologically precise manner. In addition or as an alternative to manipulator positions, the axes or, respectively, standstill positions can therefore also be predetermined depending on the time. For example, this also allows specific work spaces to be protected against damage for a limited time.

A monitoring can also similarly be initialized by an operator or by a process controller in that a corresponding input takes place if, for example, a service technician would like to temporarily safely stop a specific axis and would like to protect against unexpected startup.

For example, a standstill monitoring can be realized by detecting a real (actual) position of the selected axis or axes and stored as a desired standstill position at the beginning of the standstill monitoring. A current real position of the selected axis(s) is then detected and compared with the desired standstill position during the standstill monitoring. If the difference between the current real position and the desired standstill position exceeds a predeterminable limit value, it is established that the corresponding axis has moved beyond a tolerance range that can be predetermined by the limit value, and the axis is disconnected from its power supply. This “freezing” of the real position, as a desired position to be held at the beginning of the standstill monitoring, allows the successive monitoring of different standstill positions and is suitable both for absolute and in particular for relative measurement devices to detect the real position of an axis, for example incremental rotary encoders or resolvers.

A mechanical braking can act on the selected axis during the monitoring for a standstill. If the axis remains in the standstill monitoring even given an occurred mechanical braking or if this is activated with or after the braking occurs, a slippage of the brake can thus be detected. Braking can advantageously be monitored or checked specifically via the selection and monitoring of specific axes according to the invention.

In the preceding the present invention has been explained with reference to a selected axis to be monitored. As is clear from the example of the turning positioner, however, multiple axes of the manipulator system can be selected and monitored as a group (for example the rotation axis of the rotating table and the two workpiece rotation axes). In the event that it is detected that one of these axes is not at a standstill, this axis is disconnected from its power supply while the axes that are not selected continue to remain connected with the power supply. The other axes of the selected group can similarly continue to be connected with the power supply or can also be disconnected from their power supply.

Additional advantages and features result from the dependent Claims and the exemplary embodiments. Shown in this regard, schematically in part, are:

### BRIEF DESCRIPTION OF THE DRAWINGS

FIG. 1 schematically illustrates a manipulator system according to a first embodiment of the present invention.

FIG. 2 shows the workflow of a method to control the manipulator system of FIG. 1 according to an embodiment of the present invention.

FIG. 3 schematically illustrates a manipulator system according to a second embodiment of the present invention.

### DESCRIPTION OF THE PREFERRED EMBODIMENTS

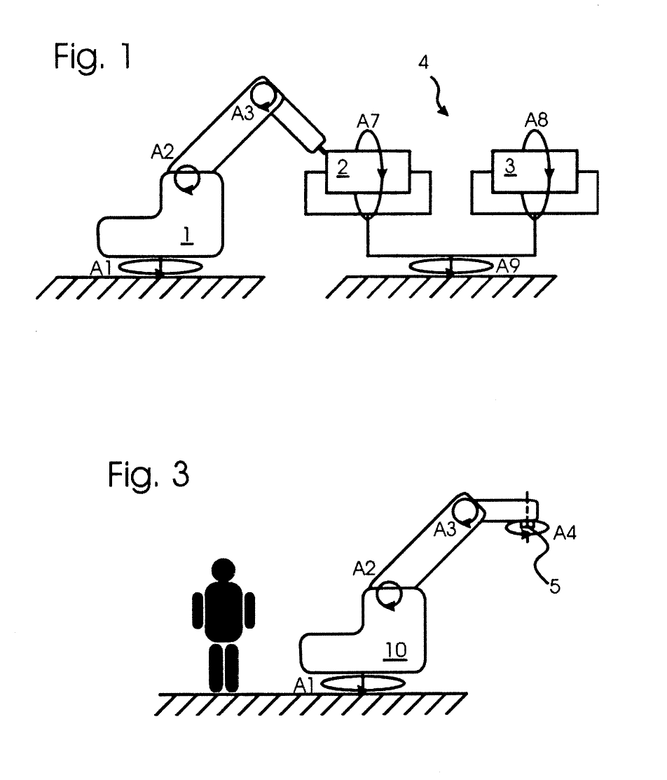

FIG. 1 shows a manipulator system according to a first embodiment of the present invention in the form of a welding cell with exchange positioner. It comprises a six-axis industrial robot 1 that has at its work point an electrode holder to process workpieces 2, 3. For clarity only the first three axes A1, A2, A3 of the robot 1 are shown.

The exchange positioner in the form of a rotating table 4 can accommodate two workpieces 2, 3 such that these can be rotated by motor around their horizontal workpiece axis A7, A8. The rotating table 4 can be rotated by motor around the additional manipulator-external vertical axis A9 in order to exchange the workpieces between a work space of the robot 1 (to the left in FIG. 1) and a manual loading station (to the right in FIG. 1). In this an operator removes a processed workpiece 3 and mounts a new workpiece to be processed while the robot 1 processes the opposite workpiece 2 in the work space. During this workpiece exchange it must be ensured that at all events the workpiece axis A8 does not move in order to prevent an injury to the operator.

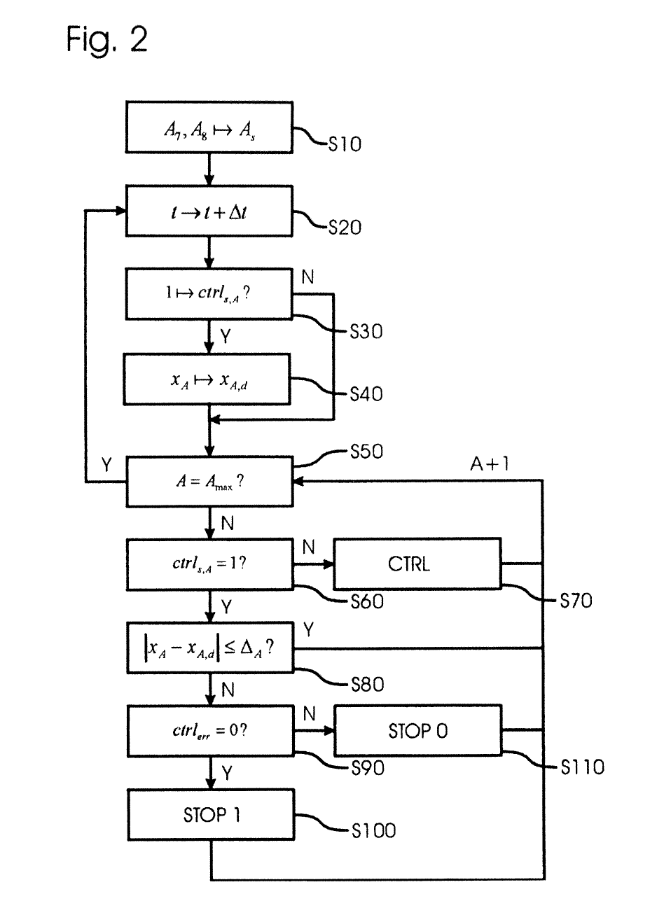

For this a device integrated into the controller of the robot 1 executes a method according to one embodiment of the present invention which is shown in simplified form in FIG. 2.

In a first Step S10 (that, in the exemplary embodiment, is implemented before startup of the robot 1, for example during the programming of the welding process), the axes to be monitored are selected, for instance the workpiece axes A7 and A8 external to the manipulator in the exemplary embodiment. In a modified embodiment the axis of the rotating table 4 can additionally also be selected; in a further modification the selection of the axes to be monitored can also take place during the operation of the manipulator system.

While the manipulator system executes the welding process—by the processing of a workpiece 2 in the work space by the robot 1 and the subsequent replacement with a new workpiece 3 by means of a rotating table 4 occurring in a synchronized manner—the method shown in Steps S20 through S110 runs periodically, as is indicated by the incrementation t→t+Δt in Step S20 and the return to this step.

During a program run-through, for all selected axes it is checked whether a monitoring of one or more axes Aₛ has been activated in that it is checked whether a corresponding input command 1→ctrl_{s,A} was received that sets a qualifier (unique identifier) ctrl_{s,A} to the value “1” in order to indicate the activation of the monitoring. Such an input command can, for example, be cyclically generated in the clocking of the workpiece exchange by a process controller—depending on the position of the robot 1—when the robot 1 approaches the workpiece 2 for processing, during which an exchange of the workpiece 3 should take place, or can be input by the operator when she would like to exchange the workpiece 3.

In the state shown in FIG. 1, in Step S30 the standstill monitoring for the axis A8 is activated in order to be able to exchange the workpiece 3 without risk. The current real position x_{A} of the axis A8 (i.e. its rotation attitude) is accordingly detected by an incremented rotation sensor and stored in Step 540 as a desired standstill position x_{A,d}. In the modified embodiment (not shown), the current real position of the axis A9 of the rotating table 4 is accordingly also detected and stored as a desired standstill position for this axis. The Step or Steps S40 are thereby only executed once given each activation of the standstill monitoring, as soon as a corresponding input command has been received.

During the subsequent standstill monitoring, for all axes of the manipulator system (or alternatively only for all selected axes; in the exemplary embodiment the axes A7, A8, in the modified exemplary embodiment the axes A7 through A9) it is checked in Step S60 (as indicated in FIG. 2 by the loop returning to Step S50) whether the qualifier ctrl_{s,A} has a value of “1”, i.e. whether the standstill monitoring for this axis is presently activated.

If this is not the case in the state shown in FIG. 1 for the first selected axis A7, this should directly move in order to suitably position the workpiece 2. The decision in Step S60 is therefore negative (“N”) and the method proceeds with

Step S70 for this axis in that the movement of the axis A7 is controlled in a predetermined manner, for example depending on the position of the robot 1 or corresponding to a predetermined time profile (“CTRL”), and its drive as well as the drives of the axes A1 through A6 of the welding robot 1 remain connected with the power supply. The program subsequently returns to Step S50 and implements this for the next axis A8.

Since the standstill monitoring for this axis is activated, the decision in Step S60 is positive (“Y”) and the method proceeds with Step S80 in which it is checked whether the difference |x_{A}-x_{A,d}| (between a real position x_{A} of the axis A8 that is detected in this time step and its desired standstill position x_{A,d} “frozen” at the beginning of the standstill monitoring upon input of the activation command in Step S30) does not exceed a predetermined limit value Δ_{A}. If this is the case (S80: “Y”), the axis A8 does not move within the scope of the tolerance predetermined by the limit value; the axis therefore remains in the normal control that continues to maintain the operating halt, and for this remains connected with the power supply.

However, if the difference |x_{A}=x_{A,d}| exceeds the limit value (S80: “N”), if the workpiece axis A8 moves in an impermissible manner, in Step S90 it is checked whether an external interference is present and the controller of the manipulator system as such works correction, for example in that a monitoring qualifier ctrlₑᵣᵣ is checked that indicates a correct function of the controller with a value of “0”.

For example, for this a force sensor can detect external forces acting on the axis A8. If such a force (a torque in the exemplary embodiment) is detected, for example if the operator attempts an unscheduled, forcible rotation of the clamped workpiece 3 around its axis A8 (which is at a standstill), the detector movement does not apply an interference to the controller; rather, this operates correctly and can be used to re-brake the axis A8. For this the monitoring qualifier ctrlₑᵣᵣ is correspondingly actively set by the force sensor to “0”, such that in Step

S90 the decision is positive (S90: “Y”). In Step S100 a STOP 1 is then executed in that the controller of the manipulator system activates the drive of the axis A8 in order to bring this to a stop, and the drive subsequently disconnects from its power supply.

By contrast, if a proper functioning of the controller cannot be ensured, in

Step S90 the decision turns out to be negative (S90: “N”). In Step S110 a STOP 0 is then executed in that the drive of the axis A8 is disconnected from its power supply. Additional mechanical braking occurs both at STOP 0 and at STOP 1 in order to bring the axis A8 to a standstill and to prevent an injury to the operator as soon as a negative decision is made in Step S80.

After the axis A8 has been processed, axis A9 is checked analogously.

In a first exemplary embodiment, for instance, a forcible rotation of the workpiece 8 by the operator thus does not lead to the situation that a STOP 1 is implemented for all axes (in particular the unselected axes A1 through A6 of the robot 1), in which STOP 1 the danger exists that the welding wire burns to ash. Rather, the robot 1 can continue the processing of the workpiece 2 without interruption since its axes have not been selected for monitoring and remain in control even given an activated standstill monitoring. According to the invention, the operation of the manipulator system can inasmuch be improved by targeted selection of the axes to be monitored.

FIG. 3 shows a manipulator system according to a second embodiment of the present invention in the form of a palletizing robot 10 with a first vertical rotation axis A1, two horizontal rotation axes A2, A3 and a fourth vertical rotation axis A4.

As long as an operator is located in front of the palletizing robot 10 (as shown in FIG. 3), the axis A1 should securely stand still in order to preclude an endangerment of the operator. For this purpose (as was explained in the preceding with reference to FIG. 1, 2) only the axis A1 is specifically selected as an axis to be monitored; upon activation of the standstill monitoring its real position is stored as a desired standstill position and this axis A1 stands still in a STOP 0 or STOP 1 in the event that its movement exceeds a tolerance range. The remaining axes A2 through A4 remain in control and connected with their power supply even given an unscheduled movement of the axis A1, such that in this case the palletizing robot 10 can also deposit a gripped load in a controlled manner, for example.

In a modification of this exemplary embodiment, mechanical brakes act on the axes A1 through A4 of the robot 10 in a mounting position. The horizontal axes A2, A3 are now selected and activated as axes to be monitored. If these slip after activation of the standstill monitoring, i.e. if the arm of the palletizing robot 10 sags when braking occurs (for example due to a usable load that is too heavy), this is advantageously detected and leads to a STOP 1 of the corresponding axis that for this is additionally braked via motor.

In a further modification of the second exemplary embodiment, the palletizing robot should, with its tool, travel a path parallel to a fence which is arranged concentric to its first vertical rotation axis A1. In order to ensure that its tool flange 5 does not deviate from this parallel path, after occupying an initial position in which the tool flange 5 has the desired horizontal distance from the fence the two horizontal axes A2, A3 are selected and their standstill monitoring is activated, as this was explained in the preceding with reference to the axis A8 of the first exemplary embodiment. The robot 10 can subsequently travel the path, wherein due to the standstill monitoring of the specifically selected horizontal rotation axes A2, A3 it is ensured that the flange 5 does not contact the fence in an unscheduled manner.

Although modifications and changes may be suggested by those skilled in the art, it is the intention of the inventor to embody within the patent warranted heron all changes and modifications as reasonably and properly come within the scope of his contribution to the art.

1-15. (canceled)

16. A method to control a manipulator system comprising the steps of:
from a computerized processor, providing control commands that operate at least two drivable axes of a manipulator system, said two drivable axes being connected with a power supply;
providing an input to said computerized processor that selects one of said axes, as a selected axis;
via said computerized processor, monitoring the selected axis for a standstill; and
via said computerized processor, automatically disconnecting the selected axis from the power supply upon detection that said selected axis is not at a standstill, while maintaining the other of said at least two drivable axes connected with said power supply.

17. A method as claimed in claim 16 comprising immediately disconnecting said selected axis from said power supply as soon as it is detected that said selected axis is not at a standstill.

18. A method as claimed in claim 16 comprising disconnecting the selected axis from the power supply after said selected axis has been brought to a standstill while supplying power thereto from said power supply.

19. A method as claimed in claim 16 comprising stopping the selected axle while supplying power thereto from said power supply when it is detected that the selected axis does not come to a standstill due to an external interference, and otherwise disconnecting the selected axis from the power supply as soon as it is detected that the selected axis is not at a standstill.

20. A method as claimed in claim 16 comprising employing at least one of said two drivable axes to move a work point of the manipulator, and operating the other of said at least two drivable axes as an axis that is external to the manipulator for movement of a workpiece.

21. A method as claimed in claim 16 comprising monitoring said selected axis for a standstill depending on a condition selected from the group of conditions comprising a state of the manipulator system, a position of a manipulator of the manipulator system, a time condition, and a condition supplied via a user input to the processor.

22. A method as claimed in claim 16 comprising:
via said processor, detecting an actual position of the selected axis at a beginning of the monitoring for a standstill, as a desired standstill position; and
subsequently detecting a current actual position of the selected axis and comparing the current actual position with the desired standstill position during monitoring of the selected axis for a standstill.

23. A method as claimed in claim 22 comprising, via said processor, detecting that selected axis is not at a standstill when a difference between said current actual position and the desired standstill position exceeds a predetermined limit value.

24. A method as claimed in claim 16 comprising, during monitoring of the selected axis for a standstill, operating on the selected axis with a mechanical brake.

25. A method as claimed in claim 16 wherein said manipulator system comprises a plurality of axes, that exceed said at least two drivable axes, and comprising:
selecting a group of at least two axes among said plurality of axes;
monitoring axes in the selected group for a standstill, and disconnecting an axis in the selected group from the power supply upon detection that said axis is not at a standstill while maintaining all other axes in said group connected with the power supply.

26. A computerized controller for controlling a manipulator system, comprising:
a computerized processor configured to provide control commands that operate at least two drivable axes of a manipulator system, said two drivable axes being connected with a power supply;
said computerized processor being configured to receive an input to said computerized processor that selects one of said axes, as a selected axis;
said computerized processor being configured to monitor the selected axis for a standstill; and
said computerized processor being configured to automatically disconnect the selected axis from the power supply upon detection that said selected axis is not at a standstill, while maintaining the other of said at least two drivable axes connected with said power supply.

27. A manipulator system comprising:
a manipulator comprising at least two drivable axes connected with a power supply;
a computerized processor configured to provide control commands that operate said at least two drivable axes of said manipulator, said two drivable axes being connected with said power supply;
said computerized processor being configured to receive an input to said computerized processor that selects one of said axes, as a selected axis;
said computerized processor being configured to monitor the selected axis for a standstill; and
said computerized processor being configured to automatically disconnect the selected axis from the power supply upon detection that said selected axis is not at a standstill, while maintaining the other of said at least two drivable axes connected with said power supply.

28. A non-transitory computer-readable storage medium encoded with programming instructions, said storage medium being loaded into a computerized control system of a manipulator system, said manipulator system comprising two drivable axes connected to a power supply, said programming instructions causing said computer system to:
provide control commands that operate at least two drivable axes of a manipulator system, said two drivable axes being connected with a power supply;
receive an input that selects one of said axes, as a selected axis;
monitor the selected axis for a standstill; and
automatically disconnect the selected axis from the power supply upon detection that said selected axis is not at a standstill, while maintaining the other of said at least two drivable axes connected with said power supply.
